(19) United States
(12) Patent Application Publication
(10) Pub. No.: US 2013/0073516 A1
(43) Pub. Date: Mar. 21, 2013

(54) Extracting Incremental Data

(71) Applicant: Xin Fan, Hangzhou (CN)

(72) Inventor: Xin Fan, Hangzhou (CN)

(73) Assignee: ALIBABA GROUP HOLDING LIMITED, Grand Cayman (KY)

(21) Appl. No.: 13/574,162

(22) PCT Filed: Jun. 22, 2012
(86) PCT No.: PCT/US12/43830

§ 371 Date: Jul. 19, 2012

(30) Foreign Application Priority Data
Jun. 23, 2011 (CN) 201110170600.9

(51) Int. Cl. G06F 17/30

(52) U.S. Cl. 707/602; 707/E17.005; 707/E17.032

(57) ABSTRACT

The present disclosure introduces a method, an apparatus, and a system for extracting incremental data. Primary key information of incremental data is obtained from a backup database. The incremental data is inquired based on the primary key information from a main database that synchronizes with the backup database. The found incremental data is then inserted into a target data warehouse. The present techniques not only save a lot of time and system resources but also improve the efficiency of incremental data extraction.

### CROSS REFERENCE TO RELATED PATENT APPLICATIONS

This application is a national stage application of an international patent application PCT/US12/43830, filed Jun. 22, 2012, which claims foreign priority to Chinese Patent Application No. 201110170600.9 filed on Jun. 23, 2011, entitled “Method, Apparatus, and System for Extracting Incremental Data,” which applications are hereby incorporated by reference in their entirety.

### TECHNICAL FIELD

The present disclosure relates to the field of data transmission technology and, more specifically, to a method, an apparatus, and a system for extracting incremental data.

### BACKGROUND

With the rapid development of the internet, data volumes displayed by websites are rapidly increasing. At the same time, data volumes transmitted between the front-end website and the back-end data warehouse are also increasing. When the back-end data warehouse performs data calculation, it needs to extract data from the front-end website.

Currently, under the conventional techniques, the data warehouse uses a hash calculation method to perform data extraction. For example, the front-end website has a table a and its data volume is around hundreds of millions. The daily incremental data is around 6 million. The data warehouse needs to extract the table's incremental data daily. The extraction process is as follows: at step A, a temporary table 1 is generated; at step B, a temporary table 2 is generated by using the data in the original table a of the data warehouse; at step C, the data in the temporary table 1 is copied into the data warehouse and is related with the temporary table 2 by using relational operations to obtain the ID values of the incremental data; and at step D, the entire incremental data is retrieved from the front-end website based on the ID values.

Obviously, at step A above, it may take 2 to 3 hours to scan the hundreds of millions of data in the table a once to generate the table 1. More time is required when the data is transmitted to the data warehouse via the network. In addition, the relational operations at step C are also very time-consuming.

Therefore, as the scale of the incremental data is continually expanding, it may take up to 5 hours or more to extract the incremental data from a large table in the above front-end website, which not only wastes a lot of time and computing resources, but also increases the delay in the data calculation at the data warehouse.

### SUMMARY

The present disclosure provides a method, an apparatus, and a system for extracting incremental data, which not only saves a lot of time and system resources, but also increases the efficiency of extraction of incremental data.

The present disclosure provides a method for extracting incremental data. A log file of a backup database is parsed and, based on the parsed contents in the log file of the backup database, the specific changed data in the backup database is inversely parsed. Primary key information is retrieved from the changed data in the backup database. One or more entire pieces of incremental data are inquired based on the primary key information from a main database that synchronizes with the backup database. The found one or more incremental data is inserted into a target data warehouse.

The present disclosure also provides an apparatus for extracting incremental data. The apparatus may include a retrieval unit, an inquiry unit, and an insertion unit. The retrieval unit parses a log file of a backup database and, based on the parsed contents in the log file of the backup database, inversely parses the specific changed data in the backup database. The retrieval unit also retrieves primary key information from the changed data in the backup database. The inquiry unit inquires one or more entire pieces of incremental data from a main database based on the primary key information. The main database synchronizes with the backup database. The insertion unit inserts the found one or more incremental data into a target data warehouse.

The present disclosure also provides a system for extracting incremental data. The system may include a main database, a backup database, a target data warehouse, and the above apparatus for extracting incremental data. The main database and the backup database store the incremental data that needs to be extracted. The stored data synchronizes between the main database and the backup database. The apparatus retrieves primary key information of the incremental data from the backup database, inquires the one or more entire pieces of incremental data from the main database based on the primary key information, and inserts the one or more entire pieces of incremental data into the target data warehouse. The target data warehouse stores the extracted one or more entire pieces of the incremental data.

The techniques of the present disclosure retrieve the changed data based on the primary key information of the incremental data, and only transmit the changed data to the data warehouse for future processing. The present techniques save a lot of time and system resources, and increase the efficiency of the incremental data extraction.

In addition, the present techniques retrieve the primary key information through the backup database, which is synchronized with the main database, and execute the inquiry operations for one or more entire pieces of incremental data from the main database based on the primary key information. The present techniques thus reduce the burden on the main database to inquire the incremental data.

### BRIEF DESCRIPTION OF THE DRAWINGS

To better illustrate embodiments of the present disclosure, the following is a brief introduction of figures to be used in descriptions of the embodiments. It is apparent that the following figures only relate to some embodiments of the present disclosure. A person of ordinary skill in the art can obtain other figures according to the figures in the present disclosure without creative efforts.

FIG. 1 illustrates a flowchart of an example method for extracting incremental data in accordance with a first example embodiment of the present disclosure.

FIG. 2 illustrates a diagram of an example apparatus for extracting incremental data in accordance with a third example embodiment of the present disclosure.

FIG. 3 illustrates a diagram of an example system for extracting incremental data in accordance with a fourth example embodiment of the present disclosure.

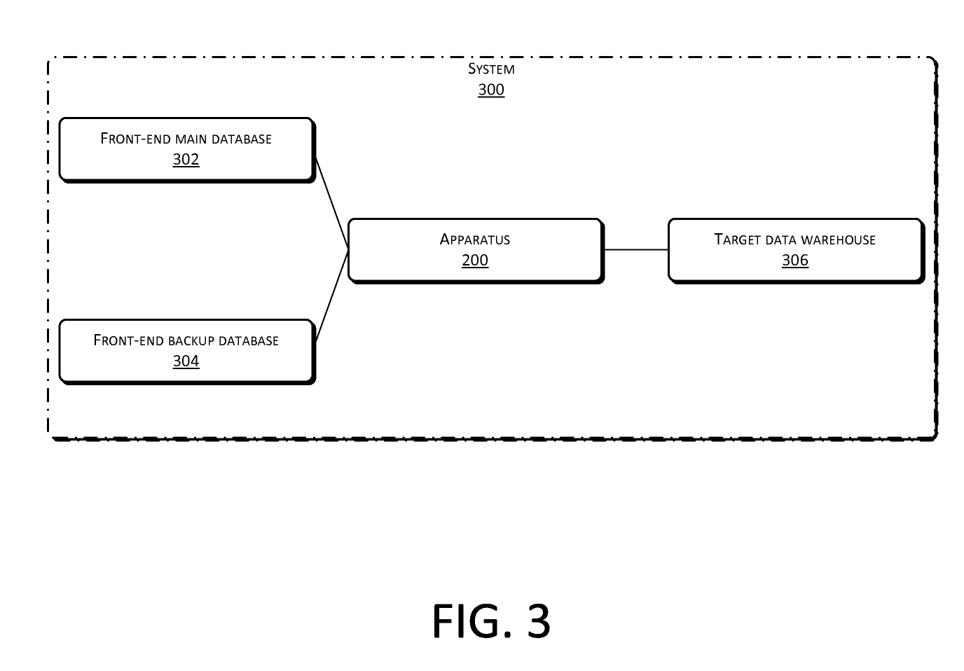

### DETAILED DESCRIPTION

The present techniques retrieve the changed data based on the primary key information of the incremental data, and, in some examples, only transmit the changed data to the data warehouse for future processing. The present techniques thus save a lot of time and system resources, and increase the efficiency of the incremental data extraction.

A person of ordinary skill in the art would appreciate that the incremental data in the present disclosure refers to changed data, such as daily changed data, at a front-end website. In practice, such incremental data may be changed data in any other form and for any other application. The incremental data is not limited to the changed data at the front-end website and is not limited to the daily changed data.

The following descriptions are made with reference to the figures. It is apparent that the following example embodiments only relate to some embodiments of the present disclosure. A person of ordinary skill in the art can obtain other embodiments according to the present disclosure without creative efforts.

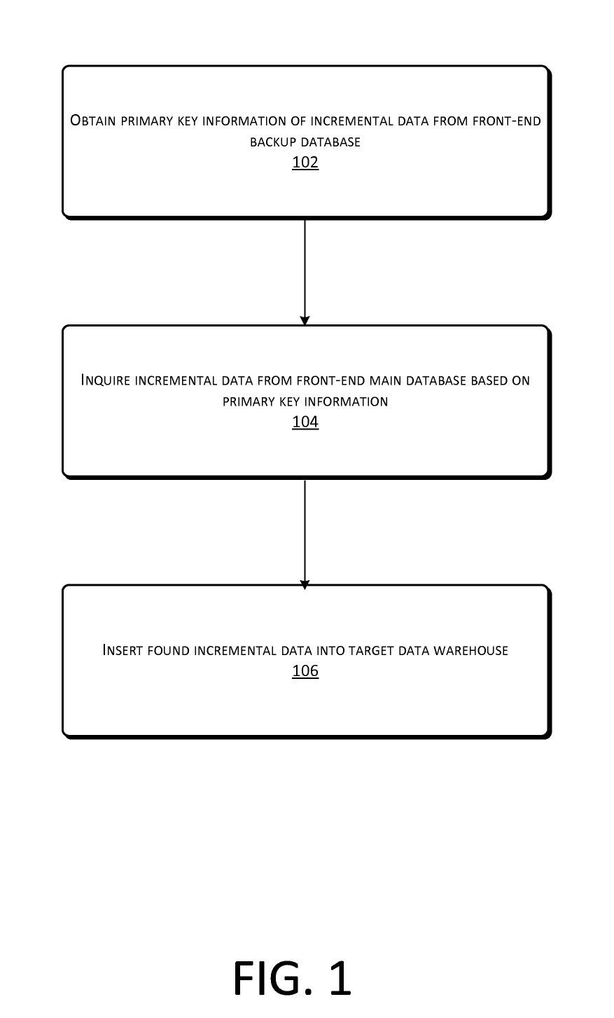

A first example embodiment of the present disclosure provides an example method for extracting incremental data. The example method may be applicable in a system including a front-end main database and a front-end backup database. FIG. 1 illustrates a flowchart of the example method for extracting incremental data in accordance with the first example embodiment of the present disclosure.

At 102, the primary key information of the incremental data is obtained from the front-end backup database. The detailed operations to obtain the primary key information may be conducted by using current technology. In addition, the first example embodiment may use, but is not limited to, the following method.

The log file of the front-end backup database is parsed. The log in the front-end backup database is usually stored in binary format. Based on the parsed contents in the log file of the front-end backup database, the specific changed data in the front-end backup database is inversely parsed. Primary key information is retrieved from the changed data in the front-end backup database.

For example, the front-end user performs an operation to add data, such as “inserting into a value (100, ‘xin’, sysdate).” To obtain the primary key information of the incremental data, the log file of the front-end backup database is parsed. Based on the parsed contents in the log file of the front-end backup database, the changed data is found. In this example, a changed data table a is obtained. The changed type is “insert” operation. The primary key information of the changed data is 100. In other words, 100 is the primary key of the incremental data. In one example, data in the front-end backup database is obtained from the front-end main database by real-time synchronization. In another example, one or more key data items, such as primary key information, instead of all data, in the front-end main database may be synchronized into the backup database. The data synchronization process may be accelerated by reducing the number of data items to be synchronized from the main database to the backup database. In addition, during the parsing of the log file in the backup database, as the log file contains a few key data items, the speed to parse the log file may also be accelerated.

At 104, one or more incremental data is inquired at the front-end main database based on the primary key information. To reduce the burden on the front-end main database due to the inquiry and extraction of the incremental database, in this example embodiment, the primary key information may be extracted from the backup database whose data is synchronized from the front-end main database, and one or more entire pieces of incremental data is inquired at the front-end main database based on the primary key information. In such circumstance, the front-end main database may be referred to as the main database and the backup database whose data is synchronized from the main database may be referred to as the backup database.

The specific inquiry operation may use an inquiry function or inquiry instruction, such as the select function. For example, the primary key information of the incremental data is 100, 108, and 200. The inquiry instruction “select * from a where id in (100, 108, 200)” may be used to search the entire pieces of the incremental data. The other detailed inquiry methods are not detailed herein.

In practice, in order to more accurately search the entire piece of incremental data, the method in this example embodiment may also include obtaining the type of change of the incremental data in addition to the primary key information. In general circumstances, the “insert” in the change operation represents that the type of change is to insert, “update” in the change operation represents that the type of change is to update, and “delete” in the change operation represents that the type of change is to delete. There may be other types of changes and the present disclosure does not detail them herein.

At 106, the found one or more incremental data is inserted to the target date warehouse. For example, the incremental data inserted into the target data warehouse may include, but is not limited to, the time of change of the incremental data, the type of change of the incremental data, and the primary key information of the incremental data.

The insertion of the found one or more entire pieces of incremental data into the target data warehouse may be achieved by using the merger technique. In other words, the found one or more entire pieces of incremental data may be merged with the original data table in the target data warehouse. Alternatively, for example, the found one or more entire pieces of incremental data may be used to replace the original data that corresponds to the incremental data in the target data warehouse. Some other methods for insertion may alternatively be used, which are not detailed herein.

The following is a detailed description of the above example method with reference to a specific incremental data extraction at the front-end website, as shown in the second example embodiment of the present disclosure.

For example, the data at the front-end website may be represented by the table t, and includes the incremental data that needs to be pushed to the data warehouse. The structure and data of the table t are shown below in Table 1, in which Id represents the primary key:

TABLE 1
Data Table of Front-end Website

| Id | Name | Age | Sex |
|---|---|---|---|
| 1 | Zhang San | 25 | male |
| 2 | Li Si | 26 | male |
| 3 | Li Li | 23 | female |

When the data at the front-end website changes at 8:00:00 on Jan. 1, 2011, the data at the Table 1 has incremental changes. For example, the changes may be as follows:

Insert into t values (4, ‘Wang Wu’, 30, male);

Update t set age=‘35’, where name=‘Li Si’

Delete from t where name=‘Zhang San’

The incremental data extraction operations may include the following operations.

At a first operation, the primary key and the type of change of the changed data may be captured from the backup database of the front-end website. For example, the data obtained from the changes in Table 1 are (4, I), (2, U), (1, D), where I, U, D represent insert, update, and delete operations, respectively, and 4, 2, 1 represent the primary key information that corresponds to each operation.

At a second operation, based on the primary key information, in this example, which are 4, 2, 1, inquiry operations, such as the select instruction, is conducted at the main database of the front-end website to inquire the one or more entire pieces of the incremental data. Data in the backup database and the main database are synchronized, which is not detailed herein.

At a third operation, the found one or more entire pieces of incremental data is inserted into the incremental table. The structure and data of the incremental table is shown in Table 2.

TABLE 2
Data Table After Extraction of Incremental Data

| log_seq | log_time | log_action | log_id | id | name | age | sex |
|---|---|---|---|---|---|---|---|
| 0 | 2010-12-13 | I | 4 | 4 | Wang | 30 | male |
| | 8:00:00 | | | | Wu | | |
| 0 | 2010-12-13 | U | 2 | 2 | Li Si | 35 | male |
| | 8:00:00 | | | | | | |
| 0 | 2010-12-13 | D | 1 | | | | |
| | 8:00:00 | | | | | | |

In Table 2, the log_seq field is reserved. The log_time represents the actual time that the data was changed in the database. The log_action has a value such as one of (I, U, D), which represents the type of change for the data. The log_id represents the primary key of the record.

At a fourth operation, the data warehouse merges the above incremental data in the incremental table with the already-stored basic table, and replaces the original data in the basic table. Thus the incremental data extraction at the front-end website is completed and the data extraction efficiency increases.

The example method uses the primary key information of the incremental data to obtain the changed data, and may, in some examples, just send the changed data to the data warehouse for further calculation, thereby saving a lot of time and system resources and greatly increasing the efficiency of the incremental data extraction.

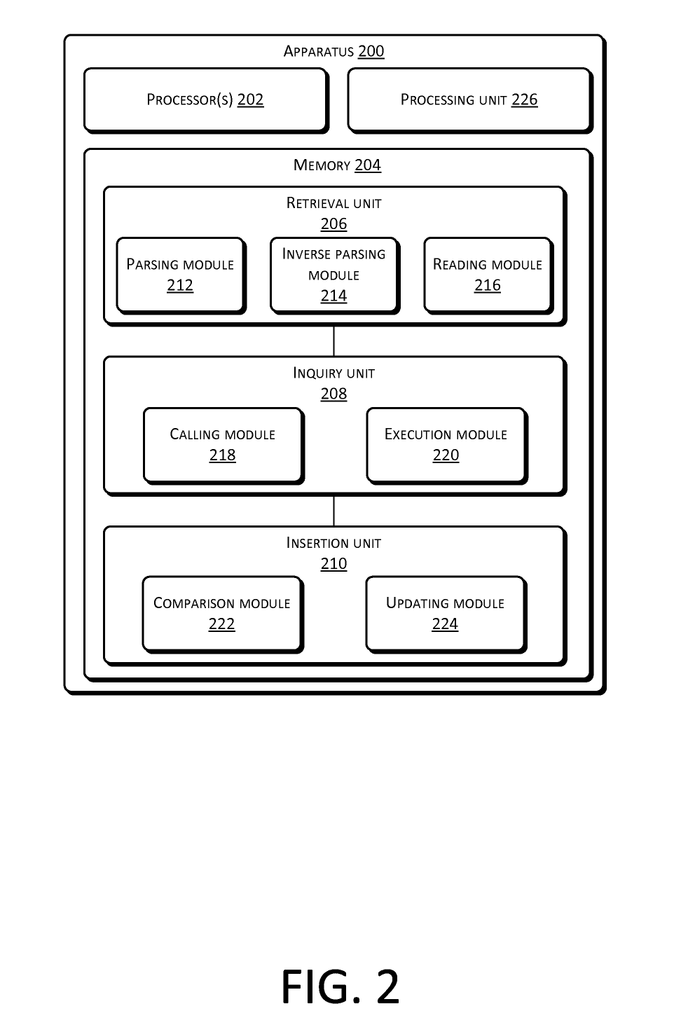

Based on the above techniques, a third example embodiment of the present disclosure provides an example apparatus for extracting incremental data as shown in FIG. 2. The apparatus 200 may include, but is not limited to, one or more processors 202 and memory 204. The memory 204 may include computer storage media in the form of volatile memory, such as random-access memory (RAM) and/or non-volatile memory, such as read only memory (ROM) or flash RAM. The memory 204 is an example of computer storage media.

Computer storage media includes volatile and non-volatile, removable and non-removable media implemented in any method or technology for storage of information such as computer-executable instructions, data structures, program modules, or other data. Examples of computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. As defined herein, computer storage media does not include transitory media such as modulated data signals and carrier waves.

The memory 204 may store therein program units or modules and program data. In one embodiment, the units may include a retrieval unit 206, an inquiry unit 208, and an insertion unit 210. These units may therefore be implemented in software that can be executed by the one or more processors 202. In other implementations, the units may be implemented in firmware, hardware, software, or a combination thereof.

The retrieval unit 206 obtains the primary key information of the incremental data from the front-end backup database. The inquiry unit 208, based on the obtained primary key information from the retrieval unit 206, inquires one or more entire pieces of incremental data from the front-end main database that synchronizes with the front-end backup database. The insertion unit 210 inserts the found one or more incremental data into a target data warehouse.

To reduce the burden on the front-end main database due to the inquiry of the incremental database, in this example embodiment, the primary key information may be extracted from the back-up database whose data is synchronized with the front-end main database, and one or more entire pieces of incremental data is inquired at the front-end main database based on the primary key information. In such circumstance, the front-end main database may be referred to as the main database and the backup database whose data is synchronized with the main database may be referred to as the backup database. This example embodiment uses the incremental data extraction at the front-end database as an example. The techniques of the present disclosure may be also applicable to the incremental data extraction at the back-end database or any other type of database. The present disclosure does not impose a restriction herein.

In this example embodiment, the retrieval unit 206 may also have the following modules that include an parsing module 212, an inverse parsing module 214, and a reading module 216. The parsing module 212 parses the log file of the front-end backup database. The inverse parsing module 214 inversely parses the parsed log file from the parsing module 212 to obtain the specific changed data in the front-end backup database. The reading module 216 retrieves primary key information from the specific changed data obtained by the inverse parsing module 214.

The inquiry unit 208 may also have the following modules that include a calling module 218 and an execution module 220. The calling module 218 calls the inquiry function or inquiry instruction. The execution module 220 uses the inquiry function or inquiry instruction called by the calling module 218 to execute inquiry operations. For example, the primary key information of the incremental data retrieved by the retrieval unit 206 is 100, 108, and 200. The calling module 218 calls the inquiry function when the inquiry operation is needed. The execution module 220 executes the inquiry function such as “select * from a where id in (100, 108, 200)” to search one or more the entire pieces of the incremental data. The details of this function are not discussed herein.

The insertion unit 210 may also have the following modules that include a comparison module 222 and an updating module 224. The comparison module 222 compares the entire piece of incremental data with the original data table in the target data warehouse. The updating module 224, based on the comparison result of the comparison module 222, updates the entire piece of incremental data into the original data table.

In another example, the apparatus 200 may also include a processing unit 226. The processing unit 226 obtains a type of change of the incremental data. Generally, in the types of change obtained by the processing unit 226, “insert” represents that the type of change is insertion, “update” represents that the type of change is updating, and “delete” represents that the type of change is deletion. There may be other types of changes and are not detailed herein.

When the apparatus 200 includes the processing unit 226, the incremental data inserted into the target data warehouse by the insertion unit 210 may include, but is not limited to, a time of change of the incremental data, a type of change of the incremental data, and the primary key information of the incremental data. This exemplary embodiment does not impose a limitation.

Based on the above techniques, the fourth example embodiment of the present disclosure provides a system 300 for extracting incremental data. The system 300 may include, but is not limited to, a front-end main database 302, a front-end backup database 304, a target data warehouse 306, and the apparatus 200 for extracting incremental data as described in the third example embodiment. The front-end main database 302 and the front-end backup database 304 store the incremental data that needs to be extracted. The stored data synchronizes between the front-end main database 302 and the front-end backup database 304. The apparatus 200 retrieves primary key information of the incremental data from the front-end backup database 304, inquires the one or more entire pieces of incremental data from the front-end main database 302 based on the primary key information, and inserts the found one or more entire pieces of incremental data into the target data warehouse 306. The target data warehouse 306 stores the extracted one or more entire pieces of the incremental data. For example, the system 300 may be a single server or in the form of a distributive system and the units are connected through a network, which may be the intranet or Internet.

One of ordinary skill in the art should understand that the embodiments of the present disclosure could be methods, systems, or the programming products of computers. Therefore, the present disclosure can be implemented by hardware, software, or in combination of both. In addition, the present disclosure can be in a form of one or more computer programs containing the computer-executable codes, which can be implemented in the computer-storage medium (including but not limited to disks, CD-ROM, optical disks, etc.). In order to more clearly explain the interchangeability of hardware and software, the present disclosure, based on functionalities, generally describes the components and steps in each example embodiment. Whether software or hardware is used to execute, the functionalities may depend on the specific application and design constraints of the technical plans. One of ordinary skill in the art may use different methods to implement the described functionalities for different applications. Such implementations shall still fall in the protection scope of the present disclosure.

The present disclosure is described by referring to the flow charts and/or block diagrams of the method, apparatus, and system of the embodiments of the present disclosure. It should be understood that each flow and/or block and the combination of the flow and/or blocks of the flowchart and/or block diagram can be implemented by computer program instructions. These computer program instructions can be provided to general computers, specific computers, embedded processors or other programmable data processors to generate a machine, so that a device of implementing one or more flows of the flow chart and/or one or more blocks of the block diagram can be generated through the instructions operated by a computer or other programmable data processors.

These computer program instructions can also be stored in a computer storage media which can instruct a computer or other programmable data processors to operate in a certain way, so that the computer-executable instructions stored in the computer storage media generate a product containing the instructions, wherein the instructions implement the functions specified in one or more flows of the flow chart and/or one or more blocks of the block diagram.

These computer program instructions can also be loaded in a computer or other programmable data processors, so that the computer or other programmable data processors can operate a series of operation steps to generate the process implemented by a computer. Accordingly, the instructions operated in the computer or other programmable data processors can provides the steps for implementing the functions specified in one or more flows of the flow chart and/or one or more blocks of the block diagram.

The above descriptions of the example embodiments allow one of ordinary skill in the art to implement or use the exemplary embodiments. The present disclosure, however, is not limited to the example embodiments and shall protect any technique that conforms to the widest scope of principles and features disclosed in this document.

The embodiments are merely for illustrating the present disclosure and are not intended to limit the scope of the present disclosure. It should be understood by one of ordinary skill in the art that certain modifications, replacements, and improvements can be made and should be considered under the protection of the present disclosure without departing from the principles of the present disclosure.

What is claimed is:

1. A method performed by one or more processors configured with computer-executable instructions, the method comprising:
obtaining primary key information of incremental data from a backup database;
inquiring incremental data at a main database, based on the obtained primary key information, synchronized between the main database and the backup database; and
inserting found incremental data into a target data warehouse.

2. The method as recited in claim 1, wherein the data synchronized between the main database and the backup database includes one or more key items of the data without inclusion of all items of the data, the one or more key items including primary key information of the data.

3. The method as recited in claim 1, wherein the backup database is a backup database of a front-end website and the main database is a main database of the front-end website.

4. The method as recited in claim 1, wherein the obtaining comprises:
parsing a log file of the backup database to obtain parsed contents;
based on the parsed contents in the log file of the backup database, inversely parsing changed data in the backup database; and
retrieving the primary key information of the changed data from the backup database.

5. The method as recited in claim 1, wherein the inquiring comprises using a search function or search instruction to inquire one or more entire pieces of incremental data from the main database based on the obtained primary key information.

6. The method as recited in claim 5, wherein each of the one or more entire pieces of incremental data includes:
a type of change of the incremental data;
a time of change of the incremental data; and
the primary key information of the incremental data.

7. The method as recited in claim 1, further comprising obtaining a type of change of the incremental data.

8. The method as recited in claim 7, wherein the type of change includes at least one of the following:
insertion arising from an insertion operation;
updating arising from an updating operation;
deletion arising from a deletion operation.

9. The method as recited in claim 1, wherein the inserting comprises merging the incremental data with an original data table at the target data warehouse.

10. An apparatus comprising:
one or more processors; and
computer storage media having stored thereon computer-executable instructions that are executable by the one or more processors to perform actions comprising:
obtaining primary key information of incremental data from a backup database, the obtaining including:
parsing a log file of the backup database;
based on the parsed contents in the log file of the backup database, inversely parsing changed data in the backup database; and
retrieving the primary key information of the changed data from the backup database;
inquiring incremental data at a main database, based on the obtained primary key information, synchronized between the main database and the backup database; and
inserting found incremental data into a target data warehouse.

11. The apparatus as recited in claim 10, wherein the inquiring comprises using a search function or search instruction to inquire one or more entire pieces of incremental data from the main database based on the obtained primary key information.

12. The apparatus as recited in claim 11, wherein the found one or more entire pieces of incremental data includes:
a type of change of the incremental data;
a time of change of the incremental data; and
the primary key information of the incremental data.

13. The apparatus as recited in claim 12, wherein the type of change includes at least one of the following:
insertion arising from an insertion operation;
updating arising from an updating operation;
deletion arising from a deletion operation.

14. The apparatus as recited in claim 10, wherein the inquiring comprises:
comparing found one or more entire pieces of incremental data with an original table at the target data warehouse; and
updating the found one or more entire pieces of incremental data into the original table based on a result of the comparing.

15. The apparatus as recited in claim 10, wherein the data synchronized between the main database and the backup database includes one or more key items of the data without inclusion of all items of the data, the one or more key items including primary key information of the data.

16. The apparatus as recited in claim 10, wherein the backup database is a backup database of a front-end website and the main database is a main database of the front-end website.

17. A system comprising:
a main database;
a backup database;
a target warehouse; and
an apparatus including:
one or more processors; and
computer storage media having stored thereon computer-executable instructions that are executable by the one or more processors to perform actions comprising:
obtaining primary key information of incremental data from a backup database, the obtaining including:
parsing a log file of the backup database;
based on the parsed contents in the log file of the backup database, inversely parsing changed data in the backup database; and
retrieving the primary key information of the changed data from the backup database;
inquiring one or more entire pieces of incremental data at a main database, based on the obtained primary key information, synchronized between the main database and the backup database; and
inserting found one or more entire pieces of incremental data into a target data warehouse.

18. The system as recited in claim 17, wherein the data synchronized between the main database and the backup database includes one or more key items of the data without inclusion of all items of the data, the one or more key items including primary key information of the data.

19. The system as recited in claim 17, wherein the one or more entire pieces of incremental data includes:
a type of change of the incremental data;
a time of change of the incremental data; and
the primary key information of the incremental data.

20. The system as recited in claim 19, wherein the type of change includes at least one of the following:
insertion arising from an insertion operation;
updating arising from an updating operation;
deletion arising from a deletion operation.
